(19) United States
(12) Patent Application Publication
(10) Pub. No.: US 2011/0167454 A1
(43) Pub. Date: Jul. 7, 2011

(54) Information processing apparatus, information processing method, and program

(75) Inventor: Daisuke Beppu, Kanagawa (JP)

(73) Assignee: Sony Corporation, Tokyo (JP)

(21) Appl. No.: 12/930,198

(22) Filed: Dec. 30, 2010

(30) Foreign Application Priority Data
Jan. 6, 2010 (JP) P2010-001535

(51) Int. Cl. H04N 5/445

(52) U.S. Cl. 725/46

(57) ABSTRACT

Provided is an information processing apparatus including: a broadcast signal processing portion to receive and reproduce a program of a channel chosen by a user; a storage portion to store preference information of the user and to store, as a user viewing history, information of channels viewed by the user; a user preference learning portion to learn the user preference information based on information about the reproduced program, and to record information of the channel of the reproduced program in a viewing history list; a feature information generating portion to select, as first channels, channels among the channels on the air based on the viewing history list, and to generate feature information of a program of the selected first channels; and a recommended program determining portion to determine a recommended program based on the feature information of the program of the channels and on the user preference information.

### CROSS-REFERENCE TO RELATED APPLICATION

The present application claims priority from Japanese Patent Application No. JP 2010-001535 filed in the Japanese Patent Office on Jan. 6, 2010, the entire content of which is incorporated herein by reference.

### BACKGROUND OF THE INVENTION

1. Field of the Invention

The present invention relates to an information processing apparatus, an information processing method, and a program, which are capable of reproducing a program including a video and determining a recommended program based on a user preference.

2. Description of the Related Art

In related art, for example, in television broadcasting and radio broadcasting, in a case of recommending a program to a user, a program matching user preference information is selected based on program information (program meta-data) of an EPG (Electronic Program Guide) and the like. A method of recommending a program to a user varies depending on a method of obtaining the user preference data. There are exemplified an initial interest registering method and a viewing history use method. In the initial interest registering method, a user is initially allowed to register information about interests of the user, and a program is recommended based on the above-mentioned information. In the viewing history use method, a viewing history of programs, which the user has been viewed, is used for recommending a program to the user.

In the initial interest registering method, at the beginning of use, the user is allowed to register the program category (for example, Drama or Variety), the genre (Mystery, Comedy, or the like), or the name of an entertainer, which the user likes. Then, through using the above-mentioned information as a keyword, matching is performed between the keyword and the program meta-data. In this manner, the name of a program to be recommended is obtained.

However, in the case where a program is selected according to the initial registration method, only fixed interests of the user at the initial time when the user has been performed the registration of his or her interests can be reflected. In addition, in order to obtain detailed information, the registration operation by the user becomes complicated, unfortunately. In a case where a smaller number of pieces of information are registered in order to simplify the input operation of the information to be registered during the initial setting in view of the above-mentioned circumstance, only recommendation based on the general preference information of the user can be performed. Thus, the accuracy of selecting a program meeting the user preference becomes lower, unfortunately.

In contrast, in the viewing history use method, every time when the user views a program, meta-data of the viewed program is accumulated. At a time when the history meta data is accumulated in some extent, the metadata is analyzed, to thereby obtain information about the program category, the genre, or the name of an entertainer, which the user likes, for example. Then, through using the above-mentioned information as a keyword, matching is performed between the keyword and the program meta-data. In this manner, the name of a program to be recommended is obtained. Therefore, it is unnecessary to perform the cumbersome registration operation by the user as in the case of the initial registration method.

Further, the following technique is disclosed as the viewing history use method. Specifically, the attribute of a program is represented as vector information for each of defined attribute items such as a title, a genre, and a performer. Meanwhile, vector information, which is similar to the above-mentioned vector information, but represents a preference of a viewer, is generated based on the viewing history. Then, the former and the later are compared to each other in order to indicate a program meeting the viewer preference (for example, Japanese Patent Application Laid-open No. 2001-160955).

### SUMMARY OF THE INVENTION

By the way, in recent years, the number of channels broadcasting programs has been increased more and more in Japan. In the area of Europe and the like, several thousands of channels have already been operated. In addition, it is expected that the channels will be even increased up to several tens of thousands of channels at the maximum as a standard.

In view of this, in the viewing history use method, determination of recommended programs is performed by comparing program each of feature amount vectors, which are generated with respect to programs in all channels, and a user preference vector, which is generated based on the viewing history of the user, to each other, and hence, as the number of channels is increased, more time is necessary for generating the program feature amount vectors. In particular, it is assumed that a television apparatus is used as the information processing apparatus to receive and reproduce a broadcast program, it is predicted that due to the processing capacity limit of the television apparatus, much time will be necessary for generating the program feature amount vectors. If much time is necessary for generating the program feature amount vectors, at a time when a recommended program meeting the user preference is determined, the recommended program may be nearing an end, or otherwise, the recommended program may have already been ended. Thus, there is a fear that it leads to a decrease of the reliability by the user with respect to the program-recommendation function.

In view of the above-mentioned circumstances, there is a need for providing an information processing apparatus, an information processing method, and a program, which are capable of more rapidly indicating a program-recommendation result to a user.

According to an embodiment of the present invention, there is provided an information processing apparatus including: a broadcast signal processing portion to receive and reproduce a program of a channel chosen by a user among a plurality of channels; a storage portion to store preference information of the user and to store, as a user viewing history, information of one or more channels viewed by the user; a user preference learning portion to perform learning of the user preference information based on information about the reproduced program, and to record information of the channel of the reproduced program in a viewing history list; a feature information generating portion to select, as first channels, one or more channels among the plurality of channels on the air based on the viewing history list, and to generate at least feature information of a program of the selected one or more first channels; and a recommended program determining portion to determine a recommended program based on the feature information of the program of the one or more channels and on the user preference information, the feature information being generated by the feature information generating portion.

In the embodiment of the present invention, the number of programs, with respect to which feature amount vectors is to be generated, is decreased, and hence the time period necessary for generating the feature amount vectors is reduced. Therefore, it is possible to more rapidly indicate a program recommendation result to a user. Further, the feature information of the program of the one or more first channels is generated based on the viewing history list, and hence it is possible to prevent programs of channels unfamiliar to the user from frequently being recommended.

The feature information generating portion may select, as the first channels, one or more channels indicated by one or more pieces of channel information, which are recorded in the viewing history list, and may randomly select, as second channels, one or more channels other than the first channels, to thereby generate pieces of feature information of programs of the first channels and the second channels. With this, channels, which the user has been viewed, are selected and, at the same time, channels, which are not found in the viewing history, are selected. Thus, there can be prevented a disadvantage in which the range of user's choice for a program to be viewed may be narrowed due to the configuration in which the channels familiar to the user are frequently recommended.

In the viewing history list, different pieces of channel information can be recorded in such a manner that an old and new relation between the different pieces of channel information at a recording time thereof can be determined, as long as the number of different pieces of channel information does not exceed a predetermined first upper limit number. When an upper limit number of pieces of channel information are recorded in the viewing history list, in a case where a program of a new channel not existing in the viewing history list is reproduced, the user preference learning portion may record information of the new channel in the viewing history list and at the same time, deletes the oldest channel information in the viewing history list. With this, it is possible to hold channel information of a program, which has been recently viewed, in the viewing history list with priority, which leads to an improvement of the reliability by the user with respect to the program-recommendation function.

The feature information generating portion may select the second channels in such a manner that a total number of first channels and second channels is within a predetermined second upper limit larger than the first upper limit. With this, it is ensured that recommended programs are determined among more programs, and hence it is possible to better determine recommended programs meeting the preference of the user.

In the viewing history list, different pieces of channel information can be recorded in such a manner that an old and new relation between the different pieces of channel information at a recording time thereof can be determined, as long as the number of different pieces of channel information does not exceed a predetermined first upper limit number. When an upper limit number of pieces of channel information are recorded in the viewing history list, in a case where a program of a channel indicated by channel information existing in the viewing history list is reproduced, the user preference learning portion may update the old and new relation at the recording time between the different pieces of channel information recorded in the viewing history list in order to cause the channel information in the viewing history list to be one that is newly recorded. Further, when an upper limit number of pieces of channel information are recorded in the viewing history list, in a case where a program of a new channel not existing in the viewing history list is reproduced, the user preference learning portion may record information of the new channel in the viewing history list and at the same time, may delete the oldest channel information in the viewing history list. With this, the channel information of the newly viewed program is recorded in the viewing history list as the latest information. Thus, it is possible to ensure the viewing history list more faithfully reflecting the actual user viewing history.

In the viewing history list, different pieces of channel information and values of the number of views of channels, which are indicated by the different pieces of channel information, can be recorded in such a state that the different pieces of channel information correspond to the values, respectively. The user preference learning portion may record, in a case where a program of a new channel not existing in the viewing history list is reproduced, information of the new channel and an initial value of the number of views in the viewing history list in such a state that the new channel information corresponds to the initial value. Further, the user preference learning portion may increment, in a case where a program of a channel indicated by channel information existing in the viewing history list is reproduced, a value of the number of views, which corresponds to the channel information in the viewing history list. The feature information generating portion may select channels indicated by a predetermined number of top pieces of information each having a large value of the number of views in the viewing history list, as the first channels. With this, the first channels, with respect to which the program feature amount vectors are to be generated, can be selected while taking the number of views (or viewing frequency) of the respective channels into consideration. Thus, it is possible to recommend programs more faithfully reflecting a user preference.

According to another embodiment, there is provided an information processing method including: receiving and reproducing, by a broadcast signal processing portion, a program of a channel chosen by a user among a plurality of channels; performing, by a user preference learning portion, learning of the user preference information based on information about the reproduced program, and recording information of the channel of the reproduced program in a viewing history list; selecting, by a feature information generating portion, one or more channels as first channels among the plurality of channels on the air based on the viewing history list, and generating at least feature information of a program of the selected one or more first channels; and determining, by a recommended program determining portion, a recommended program based on the generated feature information of the program of the one or more channels and on the user preference information.

According to still another embodiment, there is provided a program to operate a computer as: a broadcast signal processing portion to receive and reproduce a program of a channel chosen by a user among a plurality of channels; a storage portion to store preference information of the user and to store, as a user viewing history, information of one or more channels viewed by the user; a user preference learning portion to perform learning of the user preference information based on information about the reproduced program, and to record information of the channel of the reproduced program in a viewing history list; a feature information generating portion to select, as first channels, one or more channels among the plurality of channels on the air based on the viewing history list, and to generate at least feature information of a program of the selected one or more first channels; and a recommended program determining portion to determine a recommended program based on the feature information of the program of the one or more channels and on the user preference information, the feature information being generated by the feature information generating portion.

As described above, according the embodiments of the present invention, it is possible to more rapidly indicate a program-recommendation result to a user.

### BRIEF DESCRIPTION OF DRAWINGS

FIG. 1 is a view showing a configuration of an entire system including an information processing apparatus according to a first embodiment of the present invention;

FIG. 2 is a view describing an outline of selective generation of a program feature amount vector, which is performed by the information processing apparatus according to the first embodiment;

FIG. 3 is a view showing a configuration of the information processing apparatus according to the first embodiment;

FIG. 4 is a view showing a configuration of a broadcast signal processing portion;

FIG. 5 is a flowchart showing a procedure of calculating a program feature amount vector;

FIG. 6 is a flowchart showing a procedure of recording information in a viewing history list;

FIG. 7 is a flowchart showing a procedure of recommending a program;

FIG. 8 is a flowchart showing a procedure of recording information in a viewing history list in an information processing apparatus according to Modification 1; and

FIG. 9 is a flowchart showing a procedure of recording information in a viewing history list in an information processing apparatus according to Modification 2.

### DESCRIPTION OF PREFERRED EMBODIMENTS

Hereinafter, embodiments of the present invention will be described with reference to the drawings.

### First Embodiment

### [Configuration of System]

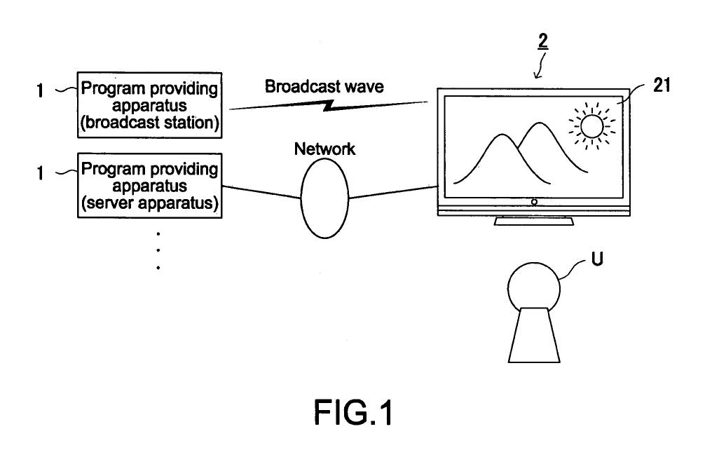

FIG. 1 is a view showing a configuration of an entire system including an information processing apparatus according to a first embodiment of the present invention. As shown in FIG. 1, this system includes one or more program-providing apparatuses 1 and an information processing apparatus 2.

Each of the program providing apparatuses 1 includes, for example, a server apparatus at a broadcast station or on a network. The program providing apparatus 1 transmits a digital broadcast program (hereinafter, referred to as “program”) via a communication media such as a ground wave, a satellite wave, or Internet. The program providing apparatus 1 is capable of multiplexing and transmitting stream packets for a program and EIT (Event Information Table) packets being information about the above-mentioned program. EIT includes a title, an explanation of the program, a channel ID (service id: information defined by broadcast standards), a program start time and a program broadcasting time (length of program), the genre of the program, parental rating information (parental control information), the presence and absence of subtitle, and charging/free, for example.

In the information processing apparatus 2, the EIT is available as an EPG (Electronic Program Guide).

The information processing apparatus 2 receives digital broadcast signals via the communication media such as the ground wave, the satellite wave, or Internet. Then, the information processing apparatus 2 separates stream packets for a program from the digital broadcast signals, and decodes the stream packets, to thereby restore video signals and audio signals for the program. After that, the information processing apparatus 2 outputs the above-mentioned video signals and audio signals through a display portion 21 and a speaker portion (not shown). Further, the information processing apparatus 2 is capable of separating the EIT packets from the received digital broadcast signals and of decoding the EIT packets, to thereby obtain EIT data. Further, the information processing apparatus 2 is capable of generating a program feature amount vector (feature information of program) through vectorizing a feature amount of the program on the air based on the above-mentioned EIT data, and is capable of saving the program feature amount vector.

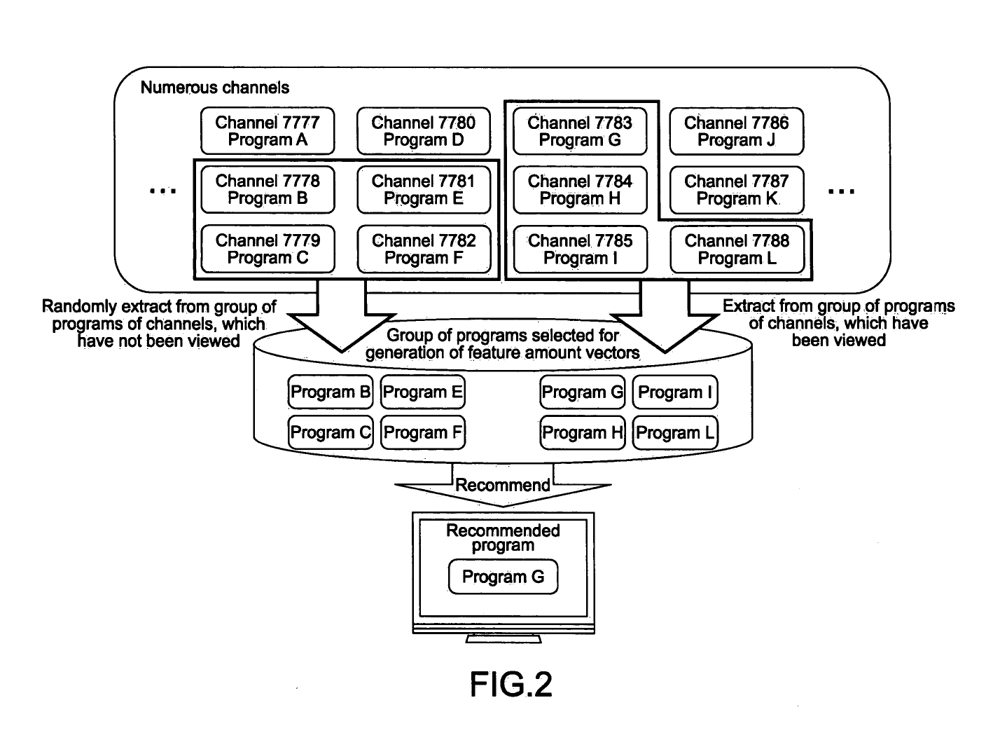

FIG. 2 is a view describing an outline of selective generation of a program feature amount vector, which is performed by the information processing apparatus 2. The information processing apparatus 2 does not perform generation of feature amount vectors, which are necessary for recommending programs, with respect to programs in all channels in the area where an enormous number of channels are operated. Instead of this, the information processing apparatus 2 selects channels, with respect to which the information processing apparatus 2 performs the generation of feature amount vectors, in advance, and then performs a program recommendation in a group of programs of the selected channels. With this configuration, the number of feature amount vectors to be generated is decreased, and the time period necessary for generating the feature amount vectors is reduced. Therefore, it is possible to more rapidly perform a program recommendation. The information processing apparatus selects channels, with respect to which the information processing apparatus 2 performs the generation of feature amount vectors, with use of the viewing history of the user, and hence it is possible to prevent programs of channels unfamiliar to the user from frequently being recommended. On the other hand, if channels familiar to the user are frequently recommended, there is a fear that the range of user's choice for a program to be viewed may be narrowed. In view of this, the information processing apparatus 2 selects channels, which the user has been viewed, and, at the same time, selects channels, which are not found in the viewing history.

It should be noted that though the information processing apparatus 2 includes, more specifically, a television apparatus, a personal computer, a player, a game machine, a portable terminal (including a telephone machine or the like), or the like, the present invention is not limited to the above-mentioned product form.

### [Details of Configuration of Information Processing Apparatus 2]

Next, the description will be made of a configuration of the information processing apparatus 2 of this embodiment.

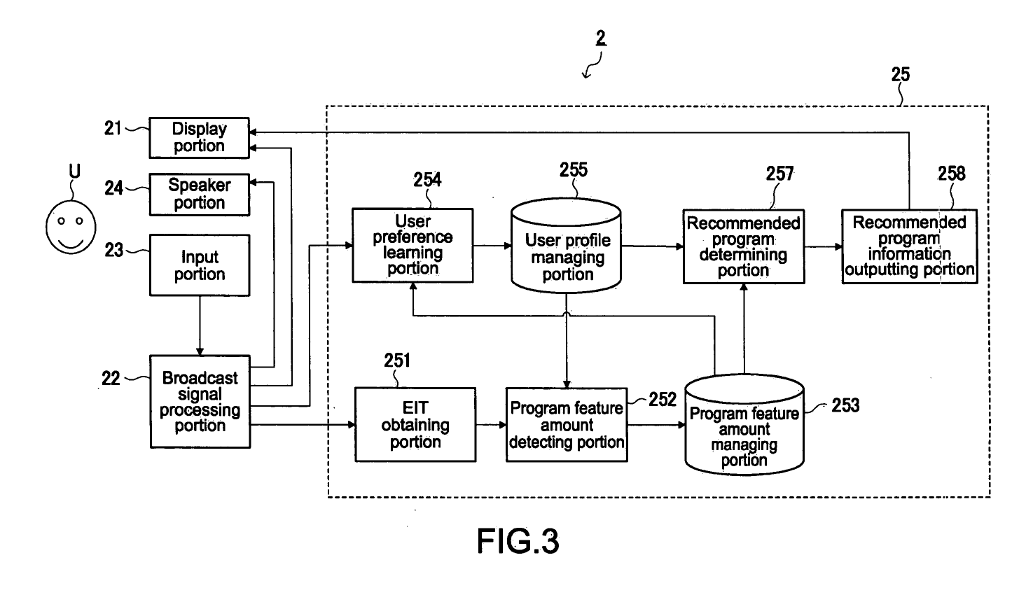

FIG. 3 is a view showing the configuration of the information processing apparatus 2.

As shown in FIG. 3, the information processing apparatus 2 includes, in addition to the display portion 21 as described above, a broadcast signal processing portion 22, an input portion 23, a speaker portion 24, and a program recommendation processing portion 25.

The broadcast signal processing portion 22 receives digital broadcast signals via a communication media such as a ground wave, a satellite wave, or Internet from the program providing apparatus 1. Then, the broadcast signal processing portion 22 separates stream packets for a program from the digital broadcast signals, and decodes the stream packets, to thereby restore video signals and audio signals for the above-mentioned program. After that, the broadcast signal processing portion 22 outputs the above-mentioned video signals and audio signals through the display portion 21 and the speaker portion 24. Further, the broadcast signal processing portion 22 separates the EIT packets from the received digital broadcast signals and decodes the EIT packets, to thereby obtain EIT data. The broadcast signal processing portion 22 will be described in details later.

The input portion 23 receives various operation commands and inputs of data from the viewers U. The input portion 23 may be one that is provided so as to be integrated with the main body of the information processing apparatus 2. Otherwise, the input portion 23 may be a remote type input portion allowing performing various operation commands and inputs of data with respect to the main body of the information processing apparatus 2 in a wireless manner.

The display portion 21 performs display driving when the video signals are input therein, the video signals being restored from the digital broadcast signals in the broadcast signal processing portion 22. The display portion 21 includes, specifically, an LCD (Liquid Crystal Display), a displayer using a display device, or the like. The display portion 21 may be one that is provided so as to be integrated with the main body of the information processing apparatus 2. Otherwise, the display portion 21 may be one that is connected to the outside of the main body of the information processing apparatus 2 through wiring for the video signals.

The speaker portion 24 performs an audio output when the audio signals are input therein, the audio signals being restored from the digital broadcast signals in the broadcast signal processing portion 22. The speaker portion 24 may be one that is provided so as to be integrated with the main body of the information processing apparatus 2. Otherwise, the speaker portion 24 may be one that is connected to the outside of the main body of the information processing apparatus 2 through wiring for the audio signals.

The program recommendation processing portion 25 performs learning of the user preference vector based on the feature amount vector of the reproduced program (program which has been viewed by the viewers U), on the viewer number, and on the actual-viewing-time percentage. Then, the program recommendation processing portion 25 performs matching between the user preference vector and the feature amount vector of each program on the air, to thereby perform the process of determining a recommended program.\

The program recommendation processing portion 25 is, more specifically, realized by a program for operating a computer including a CPU (Central Processing Unit) and a main memory. In addition, the information processing apparatus 2 includes an involatile storage portion such as a hard disk drive or a flash drive, and is capable of recording video data and audio data of the received program. It is needless to say that the information processing apparatus 2 is also capable of reproducing the video data and the audio data of the program stored in the storage portion. The CPU controls also inputs and outputs of data among the broadcast signal processing portion 22, the input portion 23, the display portion 21, the speaker portion 24, the image pick-up portion 22, and the storage portion (not shown).

### [Configuration of Broadcast Signal Processing Portion 22]

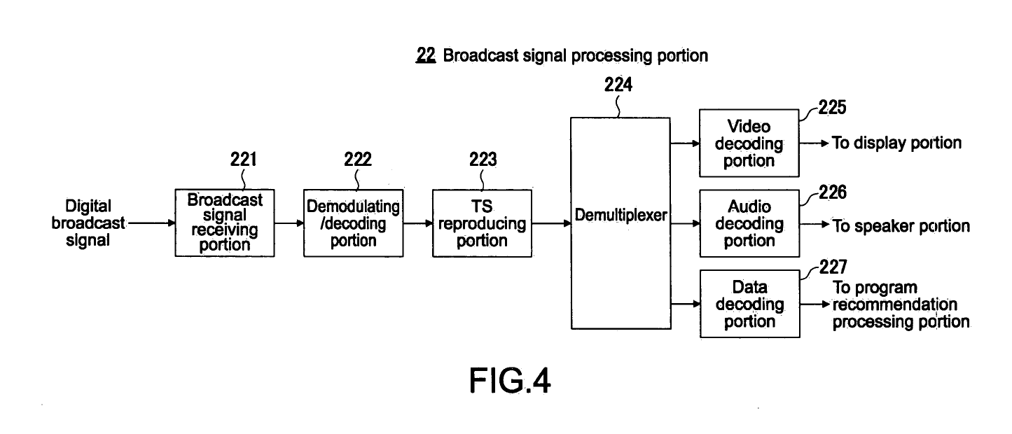

FIG. 4 is a view showing a configuration of the broadcast signal processing portion 22.

The broadcast signal processing portion 22 includes a broadcast signal receiving portion 221, a demodulating/decoding portion 222, a transport stream reproducing portion (TS reproducing portion) 223, a demultiplexer 224, a video decoding portion 225, an audio decoding portion 226, a data decoding portion 227, and the like. The above-mentioned components each have the same configuration as that of a typical receiver, which receives digital broadcast programs via a communication media such as a ground wave, a satellite wave, or Internet.

The broadcast signal receiving portion 221 includes, more specifically, a tuner and a network connection portion. The tuner receives digital broadcast signals from a selected broadcast station through an antenna via a communication media such as a ground wave or a satellite wave. The network connection portion receives IP multicast broadcast signals via a network such as Internet.

The demodulating/decoding portion 222 demodulates and decodes the digital broadcast signals, which have been received in the broadcast signal receiving portion 221, in a method corresponding to a transmission mode (demodulating method, encoding ratio, and the like). Then, the demodulating/decoding portion 222 supplies the above-mentioned digital broadcast signals to the transport stream reproducing portion 223.

The transport stream reproducing portion 223 reproduces a transport stream according to the signals supplied from the demodulating/decoding portion 222 so as to supply the transport stream to the demultiplexer 224.

The demultiplexer 224 separates, from the transport stream supplied from the transport stream reproducing portion 223, a video stream, an audio stream, and a data stream such as EIT. Then, the demultiplexer 224 supplies those streams to the video decoding portion 225, the audio decoding portion 226, and the data decoding portion 227, respectively.\

The video decoding portion 225 decodes the video stream supplied from the demultiplexer 224, and supplies video signals to the display portion 21. The audio decoding portion 226 decodes the audio stream supplied from the demultiplexer 224, and supplies audio signals to the speaker portion 24. The data decoding portion 227 decodes the data stream supplied from the demultiplexer 224, and supplies data signals to the program recommendation processing portion 25.

### [Configuration of Program Recommendation Processing Portion 25]

Referring back to FIG. 3, the description will be made of a configuration of the program recommendation processing portion 25. The program recommendation processing portion 25 includes an EIT obtaining portion 251, a program feature amount detecting portion 252 (feature information detecting portion), a program feature amount managing portion 253, a user preference learning portion 254, a user profile managing portion 255 (storage portion), a recommended program determining portion 257, and a recommended program information outputting portion 258.

The EIT obtaining portion 251 obtains and holds the EIT data received and decoded in the broadcast signal processing portion 22. Here, the EIT data to be obtained means the EIT data of the current program on the air.

The program feature amount detecting portion 252 selects, based on a viewing history list saved in the user profile managing portion 255, one or more channels, with respect to which the generation of the program feature amount vectors is to be performed, as “first channels”. At the same time, the program feature amount detecting portion 252 randomly selects one or more channels among channels other than the first channels, as “second channels”. Then, the program feature amount detecting portion 252 generates feature amount vectors with respect to programs of each channel of the selected first channels and the selected second channels.

The program feature amount managing portion 253 saves the program feature amount vectors generated by the program feature amount detecting portion 252.

The user preference learning portion 254 generates learning data of the user preference vector based on the feature amount vector of the reproduced program. That is, the user preference learning portion 254 uses the generated learning data to update (perform learning) the user preference vector, which has been saved as a user profile in the user profile managing portion 255, into the latest content. Further, the user preference learning portion 254 lists pieces of information about programs, which have been viewed by a user, and then the user preference learning portion 254 saves the listed pieces of information as the viewing history list in user profile managing portion 255.

The user profile managing portion 255 is a storage portion to save, as the user profile, the latest user preference vector, which has been updated (learned) by the user preference learning portion 254, and the viewing history list.

The recommended program determining portion 257 calculates a similarity expressed by a cosine distance between the feature amount vector of each program on the air, which has been saved in the program feature amount managing portion 253, and the user preference vector, which has been saved as the user profile in the user profile managing portion 255. Then, the recommended program determining portion 257 determines a predetermined number of top programs each having a high similarity as recommended programs.

The recommended program information outputting portion 258 extracts pieces of information about the recommended programs, which are determined by the recommended program determining portion 257, from the EIT data. Then, recommended program information outputting portion 258 indicates the pieces of information about the recommended programs through the display portion 21 to the viewers U.

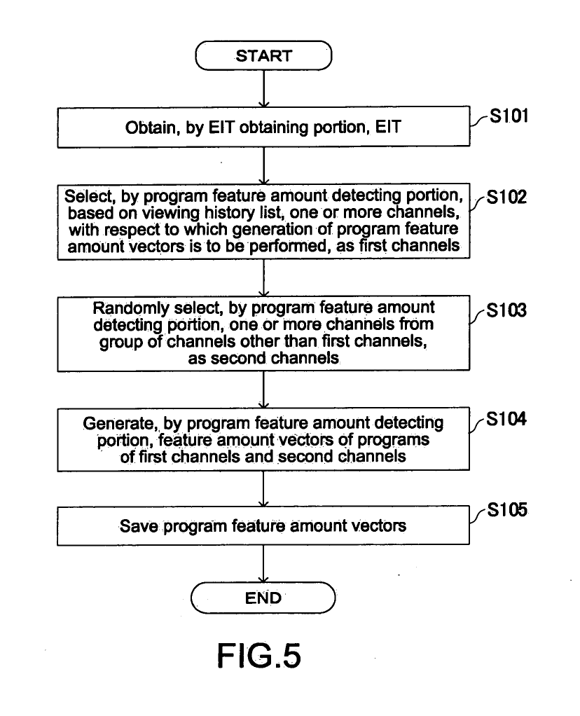

Next, with reference to FIG. 5 to FIG. 7, the description will be made of an operation of the program recommendation processing portion 25 in the information processing apparatus 2 of this embodiment.

In the program recommendation processing portion 25, the respective following processes are mainly performed: the calculation of the program feature amount vector, the information-recording into the viewing history list, the user preference learning, and the recommendation of programs. In the following, those operations will be described separately.

### [Operation of Calculating Program Feature Amount Vector]

FIG. 5 is a flowchart showing a procedure of calculating a program feature amount vector.

(Step S101) First, in the program recommendation processing portion 25, the EIT obtaining portion 251 obtains the EIT data coming from the broadcast signal processing portion 22 in such a state that the EIT data is demultiplexed on the transport stream. Then, the EIT obtaining portion 251 supplies the EIT data to the program feature amount detecting portion 252. The EIT data includes, for example, a program ID, a title, a genre, a broadcast station, a performer, a script/book/production, a content, a channel ID, a program start time and a program broadcasting time, parental rating information (parental control information), the presence and absence of subtitle, and charging/free. The EIT data obtained by the EIT obtaining portion 251 is passed to the program feature amount detecting portion 252.

(Step S102) The program feature amount detecting portion 252 receives the EIT data from the EIT obtaining portion 251. Then, the program feature amount detecting portion 252 reads the viewing history list from the user profile managing portion 255. The program feature amount detecting portion 252 selects, based on the content of the read viewing history list, one or more channels, with respect to which the generation of the program feature amount vectors is to be performed, as first channels. It should be noted that an operation of recording information in the viewing history list will be described later.

(Step S103) Next, the program feature amount detecting portion 252 randomly selects one or more channels among channels other than the first channels, as second channels.

(Step S104) Then, the program feature amount detecting portion 252 generates program feature amount vectors with respect to each channel of the selected first channels and the selected second channels.

(Step S105) The program feature amount vectors, which are detected by the program feature amount detecting portion 252 as described above, are saved in the program feature amount managing portion 253.

Now, the description will be made of a more specific method of selecting the first channel and the second channel. An upper limit of the number of channels, with respect to which the program feature amount vectors is to be generated, is set to “n”. The value “n” refers to a value to be set in advance depending on the processing capacity of the information processing apparatus 2. When the program feature amount detecting portion 252 selects, based on the content of the viewing history list, the first channels, the program feature amount detecting portion 252 selects m-channels (“m” means the number of channels) at the maximum as the first channels. Where, “m” may be smaller than “n”, and “m” may be a value to be set depending on “n”. For example, m=n/2 may be set.

As a method of selecting the first channels based on the content of the viewing history list, the following method is exemplified. Specifically, in the method, channels, which are indicated by pieces of channel information recorded in the viewing history list, are simply selected as the first channels. In this case, the number of channels, which can be recorded in the viewing history list, is set to “m”. Further, it is necessary to prevent information of the same channel from being redundantly recorded in the viewing history list. This point will be described later.

Further, the program feature amount detecting portion 252 randomly selects, among channels other than the first channels, (n−m)-channels ((n−m) means the number of channels) as the second channels.

As described above, for example, in a case where the number of channels, which can be received by the information processing apparatus 2, is 10,000 or more, when n=1024 and m=n/2 are set, “m” is 512 and n−m is also 512. Thus, in this example, 512 channels are selected as the first channels based on the viewing history list, and 512 channels are randomly selected as the second channels among channels other than the first channels.

Here, it is can be said that the programs of the first channels selected based on the viewing history list are “programs of channels familiar to the user”, and that the programs of the first channels randomly selected are “programs of channels unfamiliar to the user.” Thus, in this example, the “programs of channels familiar to the user” and the “programs of channels unfamiliar to the user” are selected in such a manner that the number of “programs of channels familiar to the user”, and the number of “programs of channels unfamiliar to the user” are equal to each other, before the program feature amount vectors are generated with respect to the programs selected in above-mentioned manner.

It should be noted that through in the above-mentioned example, m=n/2 is set, m=n−y may be set. Where “y” is smaller than “n”.

By the way, it is conceivable that the number of channels indicated by the pieces of channel information recorded in the viewing history list does not reach “m”. In this case, the program feature amount detecting portion 252 compensates for the shortfall with the number of second channels randomly selected. In this manner, “n” is ensured as the number of channels, with respect to which the feature amount vectors are to be generated. For example, in the above-mentioned example, when the number of pieces of information recorded in the viewing history list is 300, that is, less than 512, the program feature amount detecting portion 252 sets 724, which is obtained by subtracting 300 from 1024 being the value of “n,” as the number of second channels randomly selected. A probability that a recommended program meeting the preference of the user is recommended to the user becomes higher as the recommended programs are determined among more programs, and hence it is useful for the user to ensure “n” even by increasing the number of second channels randomly selected.

### [Operation of Calculating Program Feature Amount Vector]

Now, the description will be made of an operation of calculating a program feature amount vector in Step S104 of FIG. 5.

The program feature amount detecting portion 252 generates a program feature amount vector for each of the items based on the EIT data supplied by the EIT obtaining portion 251. Here, the items included in the EIT data includes, for example, a title (T), a genre (G), hours (H), a broadcast station (S), performer (A), a script/book/production (P), and a content (K). The program feature amount detecting portion 252 generates the program feature amount vector=(Tm, Gm, Hm, Sm, Pm, Am, Km) based on the content for each of the above-mentioned items. Here, each of Tm, Gm, Hm, Sm, Pm, Am, and Km means a numeral vector for each of the items in the program feature amount vector.

Here, the kind of each of the “genre,” the “broadcast station,” and the “hours” is definite, and hence the contents of each of the above-mentioned items are indicated by different numeral vectors. In a case of the broadcast station, for example, if there are 10 broadcast stations, a numeral vector Sm of the broadcast station defined as the third can be expressed by {0, 0, 1, 0, 0, 0, 0, 0, 0, 0}. Also in a case of the genre, when the genre is classified, for example, as “Drama,” “Variety,” “Sport,” “Film,” “Music,” “For children Education,” “Culture/Documentary,” “News/Report,” and “Others”, a numeral vector Gm of “Music” defined as the fifth among those can be expressed by {0, 0, 0, 0, 1, 0, 0, 0, 0}.

On the other hand, the “title,” the “performer,” the “script/book/production,” the “content,” and the like are items that cannot be each indicated by a numeral vector as they are. Therefore, with respect to those items, corresponding between an item value (word) and a weight (numeral value) is performed based on the frequency of words included in those items or the like. For example, in a case of the “title” of “Tokaido Winter Story”, its numeral vector Tm is expressed as {Tokaido=1, Winter=1, Story=1}. Here, “Tokaido=1” means that the frequency of the word of “Tokaido” is “1”.

In the above-mentioned manner, the program feature amount vector, which has been detected by the program feature amount detecting portion 252, is saved in the program feature amount managing portion 253.

### [Operation of Recording Information in Viewing History List]

Now, the description will be made of an operation of recording information in the viewing history list.

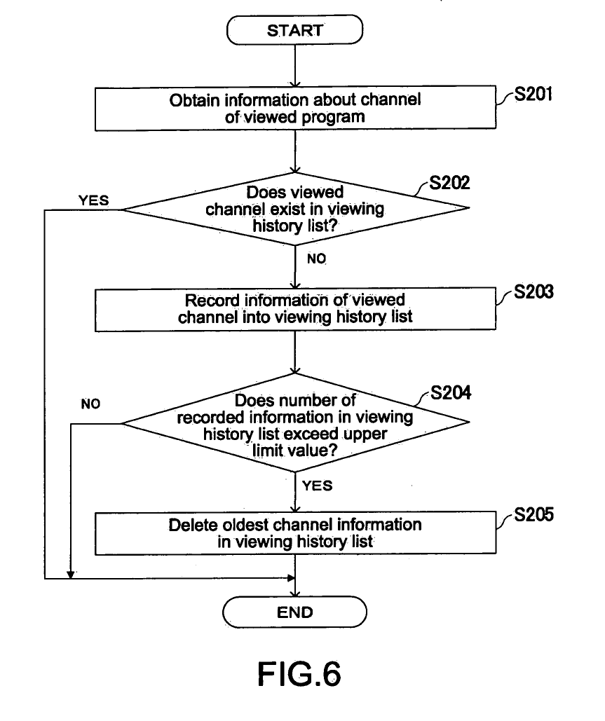

FIG. 6 is a flowchart showing a procedure of recording information in the viewing history list.

The viewing history list is configured to store pieces of channel information in such a state that the pieces of channel information are arranged in a recording order thereof in order to determine an old and new relation between the pieces of channel information at a recording time thereof. For example, a piece of channel information is set to be constantly stored at the end of the viewing history list. Thus, a piece of information at the top of the viewing history list means the oldest information over time in the viewing history list. Meanwhile, a piece of information at the end of the viewing history list is the latest information over time in the viewing history list.

(Step S201) It is assumed that in the information processing apparatus 2, a program is being reproduced. The broadcast signal processing portion 22 determines a program, which is continuously reproduced for a predetermined time period, as an actually viewed program. Then, the broadcast signal processing portion 22 notifies the user preference learning portion 254 of a program ID of the above-mentioned program. With this, the user preference learning portion 254 can be prevented from being notified of a program ID of a program, which is temporarily reproduced at a time of switching (zapping) a channel for program selection by a user.

The user preference learning portion 254 receives the notification of the program ID of the program viewed through the broadcast signal processing portion 22, and generates learning data of a user preference vector based on the program feature amount vector of the viewed program. That is, the user preference learning portion 254 uses the generated learning data to update (perform learning of) the user preference vector, which is saved as the user profile in the user profile managing portion 255, into the latest content. In addition, the user preference learning portion 254 performs a process for recording information about the viewed program, which is notified of by the broadcast signal processing portion 22, with respect to the viewing history list saved in the user profile managing portion 255. Here, the operation of recording information in the viewing history list will be referred to, and the learning of the user preference vector will be described later.

(Step S202) The user preference learning portion 254 obtains the program ID of the viewed program. Then, the user preference learning portion 254 retrieves a corresponding piece of channel information of the program in the EIT data held in the EIT obtaining portion 251, through using the program ID as a key. Then, the user preference learning portion 254 determines whether or not the channel information has already been recorded in the viewing history list. In a case where the information of the channel has already been recorded in the viewing history list, the user preference learning portion 254 terminates a routine of recording information into the viewing history list without updating the viewing history list in order to prevent the same channel information from being redundantly recorded in the viewing history list.

(Step S203) In a case where the information of the channel has not been recorded in the viewing history list, the user preference learning portion 254 records the information of the channel at the end of the viewing history list.

(Step S204) Next, the user preference learning portion 254 determines whether or not the number of pieces of information recorded in the viewing history list exceeds an upper limit value (m), to which the recording is allowed. In a case where the number of pieces of information recorded in the viewing history list does not exceed the upper limit value (m), to which the recording is allowed, the user preference learning portion 254 terminates the routine of recording information into the viewing history list without any other processes.

(Step S205) In a case where the number of pieces of information recorded in the viewing history list exceeds the upper limit value (m), to which the recording is allowed, the user preference learning portion 254 deletes the oldest information put at the top of the viewing history list.

In the above-mentioned manner, it is possible to hold channel information of a program, which has been recently viewed, in the viewing history list with priority, which leads to an improvement of the reliability by the user with respect to the program-recommendation function.

### [Operation of Learning User Preference]

Now, the description will be made of an operation of learning a user preference.

The user preference learning portion 254 receives the notification of the program ID of the program viewed through the broadcast signal processing portion 22. Then, user preference learning portion 254 generates learning data of the user preference vector based on the program feature amount vector of the viewed program. Here, in a case where the user preference vector has not yet been saved in the user profile managing portion 255, the user preference learning portion 254 simply saves the generated learning data in the user profile managing portion 255 as an initial value of the user preference vector. In a case where the user preference vector has already been saved in the user profile managing portion 255, the user preference learning portion 254 uses the generated learning data to perform an update (learning) with respect to the user preference vector, which has already been saved as the user profile in the user profile managing portion 255.

A specific example of an update (learning) of the user preference vector will be described later. For example, it is assumed that a program having a title of “Tokaido Winter Story” has been viewed. Provided that a numeral vector of the item of the “title” in the program feature amount vector of the program is set to {Tokaido=1, Winter=1, Story=1}, the user preference learning portion 254 uses this numeral vector as the generated learning data to update (perform learning of) the user preference vector, which has already been saved in the user profile managing portion 255.

The description will be made of a specific example of a method of updating the user preference vector.

For example, the user preference learning portion 254 adds the user preference vector, which has already been saved as the user profile in the user profile managing portion 255, and the learning data to each other. In this manner, the user preference learning portion 254 obtains the update result (learning result) of the user preference vector. Now, a specific example of adding the user preference vector and the learning data to each other will be described, focusing an update of the feature amount vector of the item of “the title.”

It is assumed that the feature amount vector of the item of “the title” in the user preference vector, which has already been saved as the user profile in the user profile managing portion 255, is expressed as { . . . , Tokaido=5, Winter=5, Story=5, . . . }. Provided that the feature amount vector of the item of “the title” in the learning data newly calculated at this time is expressed {Tokaido=1, Winter=1, Story=1}, an update result of { . . . , Tokaido=6, Winter=6, Story=6, . . . } is obtained by adding frequency values of the both feature amount vectors to each other. With respect to feature amount vectors for other items, updates are performed similarly.

It should be noted that though in the above-mentioned example, the result of adding the user preference vector, which has already been saved as the user profile in the user profile managing portion 255, to the learning data is set to be the update result of the user preference vector, an averaging result thereof may be set to be the update (learning) result of the user preference vector.

### [Operation of Learning User Preference of Recommending Program]

Next, the description will be made of an operation of recommending a program.

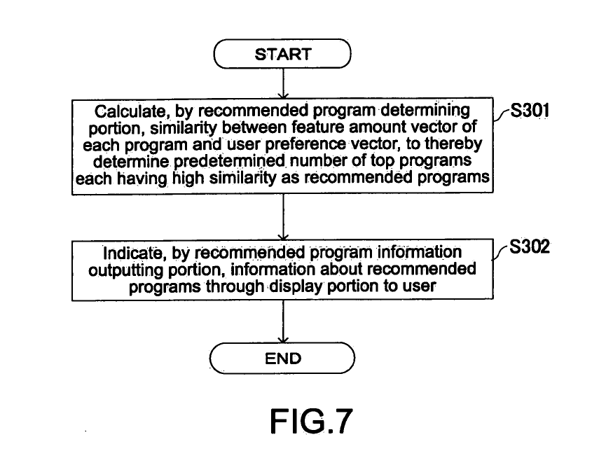

FIG. 7 is a flowchart showing a procedure of recommending a program by the program recommendation processing portion 25.

(Step S301) In response to generation of a predetermined event, the recommended program determining portion 257 calculates a similarity expressed by a cosine distance between the program feature amount vector of each program, which has been saved in the program feature amount managing portion 253, and the user preference vector, which has been saved as the user profile in the user profile managing portion 255. In this manner, the recommended program determining portion 257 determines a predetermined number of top programs each having a high similarity as recommended programs. Then, the recommended program determining portion 257 outputs program IDs of the recommended programs as the determining result to the recommended program information outputting portion 258.

The predetermined event includes, for example, an update of the user preference vector, which has already been saved as the user profile in the user profile managing portion 255, the actuation of the system of the information processing apparatus 2, an input of a request of displaying a recommended program, which is performed by a user, and a predetermined time period. The user may be allowed to set a desired event among those events with respect to the information processing apparatus 2. It should be noted that items, which the user can set, include, in addition to the above-mentioned items, the number of programs to be recommended, a sort condition for displaying the recommended programs, an item being a target of the user preference learning, and the like.

(Step S302) The recommended program information outputting portion 258 receives the program IDs of the recommended programs being as the determining result from the recommended program determining portion 257. Then, the recommended program information outputting portion 258 retrieves corresponding pieces of information about the recommended programs in the EIT data held in the EIT obtaining portion 251, through using each of the program IDs as a key. Then, the recommended program information outputting portion 258 indicates the retrieved pieces of information about the recommended programs through the display portion 21 to the viewer(s) U.

As described above, in the area where an enormous number of channels are operated, the information processing apparatus 2 according to this embodiment selects channels, with respect to which the information processing apparatus 2 performs the generation of feature amount vectors, in advance, and then performs a program recommendation in a group of programs of the selected channels. With this configuration, the number of feature amount vectors to be generated is decreased, and the time period necessary for generating the feature amount vectors is reduced. Therefore, it is possible to more rapidly indicate a program recommendation result to a user.

Further, in the information processing apparatus 2 according to this embodiment, the viewing history of the user is used to select a channel, with respect to which the generation of feature amount vectors is to be performed. Thus, it is possible to prevent programs of channels unfamiliar to the user from frequently being recommended.

In addition, in the information processing apparatus 2 according to this embodiment, channels, which the user has been viewed, are selected and, at the same time, channels, which are not found in the viewing history, are selected. Thus, there can be prevented a disadvantage in which the range of user's choice for a program to be viewed may be narrowed due to the configuration in which the channels familiar to the user are frequently recommended.

### [Modification 1]

Now, the description will be made of Modification 1 of the first embodiment according to the present invention.

In the information processing apparatus 2A of the first embodiment, in order to prevent the same piece of channel information from being redundantly recorded in the viewing history list, in a case where a piece of channel information of a program newly viewed has been already recorded in the viewing history list, the user preference learning portion 254 is set not to record the piece of channel information of the newly viewed program in the viewing history list. However, in the case of this method, after the piece of information is recorded in the viewing history list, even when the corresponding channel is selected again, the position of the above-mentioned piece of channel information in the viewing history list is not changed. Thus, the piece of channel information will be deleted from the viewing history list at any time in point.

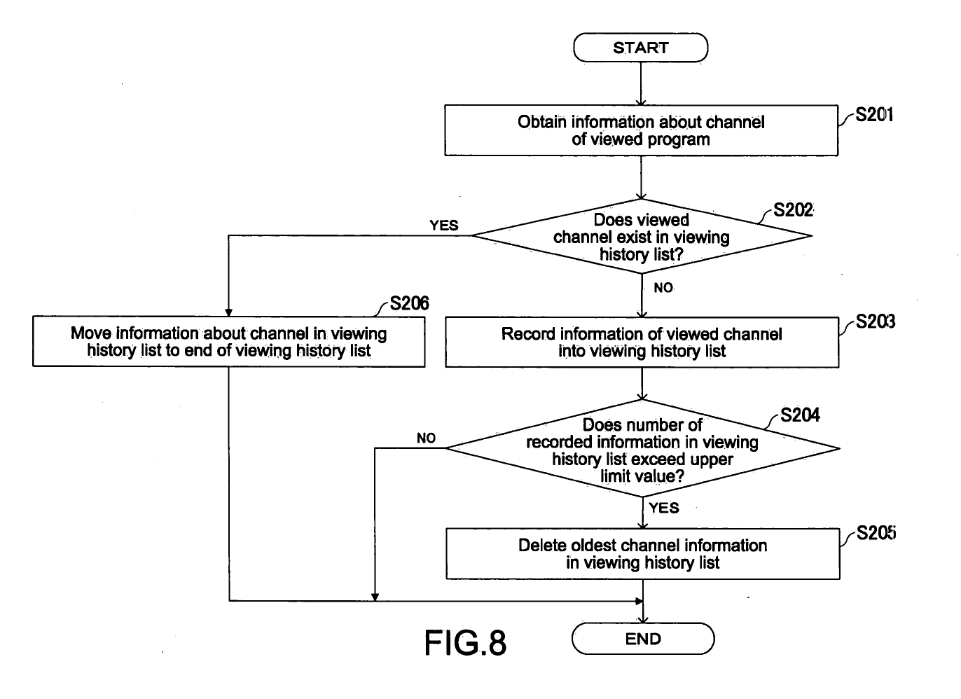

FIG. 8 is a flowchart showing a procedure of recording information in the viewing history list in an information processing apparatus according to Modification 1.

In the information processing apparatus according to Modification 1, in a case where a piece of channel information of the program newly viewed has been already recorded in the viewing history list, the user preference learning portion 254 causes the piece of information of the channel in the viewing history list to move at the end of the viewing history list (Step S206). With this, the piece of channel information of the newly viewed program is recorded in the viewing history list as the latest information. Thus, it is possible to ensure the viewing history list more faithfully reflecting the actual user viewing history.

### [Modification 2]

The user preference learning portion 254 may record, in the viewing history list, a piece of channel information and the number of views (or viewing frequency) of the channel correspondingly to the piece of channel information at the same time.

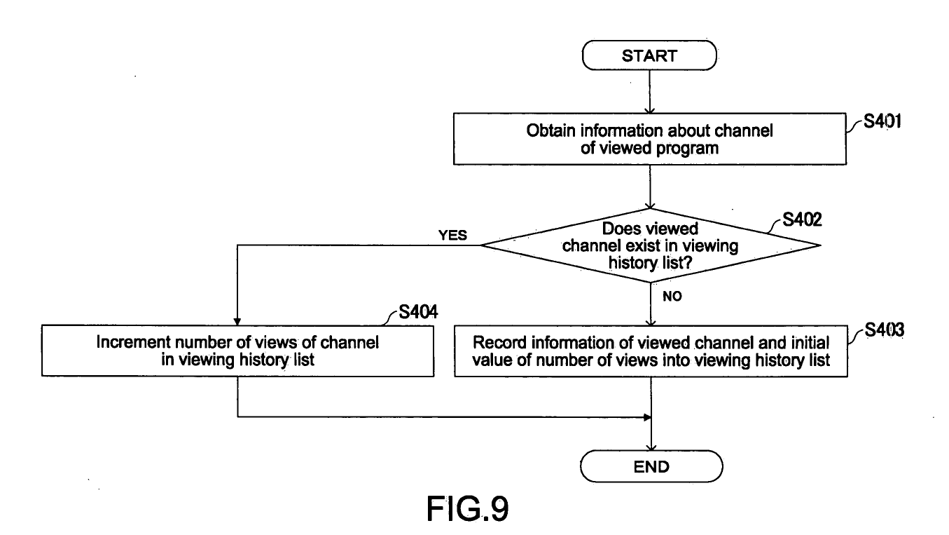

FIG. 9 is a flowchart showing a procedure of recording information in the viewing history list in an information processing apparatus according to Modification 2.

(Step S401) It is assumed that in the information processing apparatus 2, a program is being reproduced. The broadcast signal processing portion 22 determines a program, which is continuously reproduced for a predetermined time period, as an actually viewed program. Then, the broadcast signal processing portion 22 notifies the user preference learning portion 254 of a program ID of the above-mentioned program. With this, the user preference learning portion 254 can be prevented from being notified of a program ID of a program, which is temporarily reproduced at a time of switching (zapping) a channel for program selection by a user.

The user preference learning portion 254 receives the notification of the program ID of the program viewed through the broadcast signal processing portion 22. Then, the user preference learning portion 254 generates learning data of the user preference vector based on the program feature amount vector of the viewed program. The user preference learning portion 254 uses the learning data to update (perform learning of) the user preference vector into the latest content. In addition, the user preference learning portion 254 performs a process for recording information about the viewed program, which is notified of by the broadcast signal processing portion 22, with respect to the viewing history list saved in the user profile managing portion 255. Now, the operation of recording information in the viewing history list will be referred to, and the description of the learning of the user preference vector will be omitted because it is similar to that of the first embodiment.

(Step S402) The user preference learning portion 254 obtains the program ID of the viewed program. Then, the user preference learning portion 254 retrieves a corresponding piece of channel information of the programs in the EIT data held in the EIT obtaining portion 251, through using the program ID as a key. Then, the user preference learning portion 254 determines whether or not the piece of channel information has already been recorded in the viewing history list.

(Step S403) In a case where the piece of information of the channel has not been recorded in the viewing history list, the user preference learning portion 254 records the piece of information about the channel and an initial value of the number of views in the viewing history list.

(Step S404) Further, in a case where the piece of information about the channel has already been recorded in the viewing history list, the user preference learning portion 254 increments a value of the number of views corresponding to the piece of information about the channel in the viewing history list.

The program feature amount detecting portion 252 selects a predetermined number (m) of top channels indicated by pieces of channel information, each of which has a high value of the number of views in the viewing history list, as the first channels. With this, the first channels, with respect to which the program feature amount vectors are to be generated, can be selected while taking the number of views (or viewing frequency) of each of the channels into consideration. Thus, it is possible to recommend programs more faithfully reflecting a user preference.

### [Modification 3]

As a further modification of Modification 2, the following is conceivable.

After Step S404 of Modification 2, the user preference learning portion 254 changes the order in which pieces of information are arranged in such a manner that the pieces of information in the viewing history list are arranged in decreasing order of the number of views of channels. On the other hand, after Step S403 of Modification 2, the user preference learning portion 254 determines whether or not the number of pieces of information recorded in the viewing history list exceeds the upper limit value (m). In a case where the number of pieces of information recorded in the viewing history list exceeds the upper limit value (m), the user preference learning portion 254 deletes the oldest information (information put at the top of viewing history list) in the viewing history list. Then, the program feature amount detecting portion 252 simply selects channels indicated by the pieces of channel information recorded in the viewing history list as the first channels. With this, the pieces of information are deleted from the viewing history list in increasing order of the number of views (or viewing frequency) regarding each of the channels. Thus, it is possible to ensure the viewing history list more faithfully reflecting the actual user viewing history. The present invention is not limited to the above-mentioned embodiments, and various modifications can be made without departing from the gist of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a broadcast signal processing portion to receive and reproduce a program of a channel chosen by a user among a plurality of channels;
a storage portion to store preference information of the user and to store, as a user viewing history, information of one or more channels viewed by the user;
a user preference learning portion to perform learning of the user preference information based on information about the reproduced program, and to record information of the channel of the reproduced program in a viewing history list;
a feature information generating portion to select, as first channels, one or more channels among the plurality of channels on the air based on the viewing history list, and to generate at least feature information of a program of the selected one or more first channels; and
a recommended program determining portion to determine a recommended program based on the feature information of the program of the one or more channels and on the user preference information, the feature information being generated by the feature information generating portion.

2. The information processing apparatus according to claim 1,
wherein the feature information generating portion selects, as the first channels, one or more channels indicated by one or more pieces of channel information, which are recorded in the viewing history list, and randomly selects, as second channels, one or more channels other than the first channels, to thereby generate pieces of feature information of programs of the first channels and the second channels.

3. The information processing apparatus according to claim 2,
wherein in the viewing history list, different pieces of channel information can be recorded in such a manner that an old and new relation between the different pieces of channel information at a recording time thereof can be determined, as long as the number of different pieces of channel information does not exceed a predetermined first upper limit number, and
wherein when an upper limit number of pieces of channel information are recorded in the viewing history list, in a case where a program of a new channel not existing in the viewing history list is reproduced, the user preference learning portion records information of the new channel in the viewing history list and at the same time, deletes the oldest channel information in the viewing history list.

4. The information processing apparatus according to claim 3,
wherein the feature information generating portion selects the second channels in such a manner that a total number of first channels and second channels is within a predetermined second upper limit larger than the first upper limit.

5. The information processing apparatus according to claim 2,
wherein in the viewing history list, different pieces of channel information can be recorded in such a manner that an old and new relation between the different pieces of channel information at a recording time thereof can be determined, as long as the number of different pieces of channel information does not exceed a predetermined first upper limit number,
wherein when an upper limit number of pieces of channel information are recorded in the viewing history list, in a case where a program of a channel indicated by channel information existing in the viewing history list is reproduced, the user preference learning portion updates the old and new relation at the recording time between the different pieces of channel information recorded in the viewing history list in order to cause the channel information in the viewing history list to be one that is newly recorded, and
wherein when an upper limit number of pieces of channel information are recorded in the viewing history list, in a case where a program of a new channel not existing in the viewing history list is reproduced, the user preference learning portion records information of the new channel in the viewing history list and at the same time, deletes the oldest channel information in the viewing history list.

6. The information processing apparatus according to claim 2,
wherein in the viewing history list, different pieces of channel information and values of the number of views of channels, which are indicated by the different pieces of channel information, can be recorded in such a state that the different pieces of channel information correspond to the values, respectively,
wherein the user preference learning portion records, in a case where a program of a new channel not existing in the viewing history list is reproduced, information of the new channel and an initial value of the number of views in the viewing history list in such a state that the new channel information corresponds to the initial value,
wherein the user preference learning portion increments, in a case where a program of a channel indicated by channel information existing in the viewing history list is reproduced, a value of the number of views, which corresponds to the channel information in the viewing history list, and
wherein the feature information generating portion selects channels indicated by a predetermined number of top pieces of information each having a large value of the number of views in the viewing history list, as the first channels.

7. An information processing method, comprising:
receiving and reproducing, by a broadcast signal processing portion, a program of a channel chosen by a user among a plurality of channels;
performing, by a user preference learning portion, learning of the user preference information based on information about the reproduced program, and recording information of the channel of the reproduced program in a viewing history list;
selecting, by a feature information generating portion, one or more channels as first channels among the plurality of channels on the air based on the viewing history list, and generating at least feature information of a program of the selected one or more first channels; and
determining, by a recommended program determining portion, a recommended program based on the generated feature information of the program of the one or more channels and on the user preference information.

8. A program to operate a computer as:
a broadcast signal processing portion to receive and reproduce a program of a channel chosen by a user among a plurality of channels;
a storage portion to store preference information of the user and to store, as a user viewing history, information of one or more channels viewed by the user;
a user preference learning portion to perform learning of the user preference information based on information about the reproduced program, and to record information of the channel of the reproduced program in a viewing history list;
a feature information generating portion to select, as first channels, one or more channels among the plurality of channels on the air based on the viewing history list, and to generate at least feature information of a program of the selected one or more first channels; and
a recommended program determining portion to determine a recommended program based on the feature information of the program of the one or more channels and on the user preference information, the feature information being generated by the feature information generating portion.
